(19) United States
(12) Patent Application Publication
(10) Pub. No.: US 2016/0092152 A1
(43) Pub. Date: Mar. 31, 2016

(54) EXTENDED SCREEN EXPERIENCE

(71) Applicant: Oracle International Corporation, Redwood Shores, CA (US)

(72) Inventors: Noel Portugal, Cedar Park, TX (US); Jeremy Ashley, San Francisco, CA (US)

(21) Appl. No.: 14/609,103

(22) Filed: Jan. 29, 2015

Related U.S. Application Data
(60) Provisional application No. 62/055,488, filed on Sep. 25, 2014.

(51) Int. Cl. G06F 3/14; G09G 5/00

(52) U.S. Cl. CPC G06F 3/1438; G09G 5/005

(57) ABSTRACT

A system and method for facilitating leveraging computing resources to convey or otherwise illustrate information. An example method includes receiving a signal from a user input mechanism of a first device, the first device characterized by the user input mechanism in communication with a first display; displaying a first layout on the first display in response to the signal; and generating instructions for a second user interface layout for presentation on a second display that is larger than the first display, wherein content of the second layout is coordinated with content of the first layout, which are associated with a software application, and wherein the second layout includes one or more additional visual features relative to the first layout.

### CROSS REFERENCES TO RELATED APPLICATIONS

This application claims priority from U.S. Provisional Patent Application Ser. No. 62/055,488, entitled EXTENDED SCREEN EXPERIENCE, filed on Sep. 25, 2014, which is hereby incorporated by reference as if set forth in full in this application for all purposes.

This application is related to the following U.S. Patent Applications, U.S. patent application Ser. No. 14/024,530 (Atty. docket no. ORACP0091-1-ORA130591-US-NP-1), entitled DESKTOP AND MOBILE DEVICE INTEGRATION, filed on Sep. 11, 2013; U.S. patent application Ser. No. 14/535,273 (Atty. docket no ORACP0125-ORA140865-US-NP), entitled DEVICE FORM FACTOR DETECTION AND EMULATION, filed on Nov. 4, 2014, which are hereby incorporated by reference, as if it is set forth in full in this specification.

### BACKGROUND

The present application relates to computing, and more specifically to software and accompanying user interface display screens and methods for using multiple computing device displays or other resources.

Software and methods for utilizing multiple displays are employed in various demanding applications, including software for utilizing split screen functionality; streaming media applications using desktop device displays and set-top box displays; extended screen experiences whereby a smaller mobile device screen augments or compliments information displayed on a larger display screen, and so on.

Such applications can demand efficient methods for leveraging computing resources to effectively utilize viewable areas provided by different display mechanisms. However, conventional technologies for leveraging multiple displays, e.g., screen minoring, video streaming, and so on, often lack mechanisms for fully utilizing viewable display areas.

### SUMMARY

An example method facilitates leveraging computing resources to convey or otherwise illustrate information. The example method includes receiving a signal from a user input mechanism of a first device that includes a first display; displaying a first user interface display screen on the first display in response to the signal; and generating rendering instructions for a second user interface display screen for presentation thereof on a second display that is larger than the first display. Content of the second user interface display screen is coordinated with content of the first user interface display screen, the user interface display screens of which are associated with or derived via a software application. The second user interface display screen includes one or more additional visual features or functionality relative to the first user interface display screen to capitalize on additional display space afforded by the second display relative to the first display.

Another illustrative method includes employing a client device to determine a difference between a first computing resource and a second computing resource; obtaining a first set of information and a second set of information based on the difference, wherein the second set of information is augmented relative to the first set of information; generating a first set of computer instructions adapted to enable a first computing resource to convey the first set of information; providing a second set of computer instructions adapted to enable a second computing resource to convey a second set of information; and coordinating delivery of the first set of information and the second set of information to the first computing resource and the second computing resource, respectively.

In a more specific example embodiment, the first computing resource includes the first display, and the second computing resource includes the second display that is larger than the first display. The difference represents a difference in viewable display areas between the first display and the second display. The first set of information and the second set of information include overlapping visual information.

The client device may include or represent an appliance, such as a set-top box. The appliance communicates with the first computing resource, such as a mobile device display, and the second computing resource, such as a television, desktop computer display, or projector and projection surface.

Alternatively, or in addition, the client device includes a mobile device that is adapted to transmit rendering instructions to the second display. The rendering instructions are adapted to leverage additional display area of the second display relative to the display area of the first display. The first computer instructions and the second computer instructions may include rendering instructions derived from output of a single software application.

The first set of information may include visual information adapted for presentation of a first user interface display screen on the first display. The second set of information may include visual information adapted for presentation on a second user interface display screen on the second display.

The second user interface display screen may represent a reformatted version of the first user interface display screen. The second user interface display screen may also include information present in the first user interface display screen that is integrated with or blended with additional information, such as visual information and/or user interface controls or features that are not present in the first user interface display screen but nevertheless are synchronized or coordinated therewith.

In another example embodiment, the first computing resource and the second computing resource include first and second speaker systems, respectively. The first set of information includes information contained in a first audio signal tailored for use by the first computing resource.

Similarly, the second set of information includes enhanced or augmented information contained in a second audio signal tailored for use by the second computing resource. The second speaker system may include or provide access to additional functionality relative to the first speaker system. The additional functionality may be adapted to use additional information contained in the second audio signal relative to the first audio signal.

In another example embodiment, the first display includes a mobile device display, and the second display includes a projected display. The different user interface display screens presented on the different displays are characterized by different layouts in accordance with the different display sizes and/or other capabilities.

Note that in general, while the software industry has been focusing on using relatively small mobile device displays to augment relatively larger desktop computer displays, use of smaller displays to strategically augment smaller displays has largely been ignored, other than for simple minoring applications, whereby a mobile device display is mirrored or replicated on a larger display.

Certain embodiments discussed herein facilitate enabling users to employ mobile devices or other appliances to selectively transmit visual information in accordance with different display sizes and capabilities of the destination devices. The visual information may be reformatted, augmented, or otherwise modified in accordance with characteristics of the different displays. Larger displays may enable richer media assets to accompany datasets provided by a given software application.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a basic pictorial diagram showing example components of a first example embodiment.

FIG. 2 shows an example enterprise computing environment and accompanying system in accordance with a second embodiment for enabling use of a mobile device to facilitate display of content on a mobile device display and display of enhanced or augmented content on a larger display of a desktop computer.

FIG. 3 shows an example system in accordance with a third embodiment usable with the embodiment of FIG. 1 and employing an appliance, such as a set-top box, to facilitate coordinating content delivery to a mobile device and television system in accordance with characteristics of computing resources of each system, e.g., display size.

FIG. 4 shows a first set of user interface display screens, including a smaller user interface display screen that is coordinated with a larger user interface display screen, which includes augmented and/or reformatted content relative to the smaller user interface display screen, and which may be implemented via the embodiments of FIGS. 1-3.

FIG. 5 shows a second set of user interface display screens, including a user interface display screen of a smaller display coordinated with that of a larger display.

FIG. 6 is a flow diagram of a first example method that is adapted for use with the embodiments of FIGS. 1-5.

FIG. 7 is a flow diagram of a second example method that is adapted for use with the embodiments of FIGS. 1-6.

FIG. 8 is a flow diagram of a third example method that is adapted for use with the embodiments of FIGS. 1-7.

### DETAILED DESCRIPTION OF EMBODIMENTS

A smaller screen system, such as a mobile phone, tablet, phablet, smart watch or other wearable computing device, laptop, desktop, etc., can be used to invoke a parallel screen display on a system with a larger screen (i.e., “larger screen system”). The larger screen system can be a television, projection display, desktop, laptop, mobile phone, or potentially any system that has a larger display screen than the smaller screen system. This allows additional visual information, formatting, graphical cues, alphanumeric text or other visualizations to be used to provide benefits to a person viewing the larger display screen. In general, any system can be considered the “larger” or “smaller” screen system as long as the associated larger display is relatively larger than the smaller display. For example, a smartphone can be considered a larger screen system relative to the smaller screen system of a smart watch or other computerized device worn on the wrist. Many such combinations are possible.

For example, if a person doing a presentation brings up a list of sales leads or opportunities on their smartphone, the small display on the smartphone might show a simple list of names of sales leads along with a few navigational and menu controls. Simultaneously, a display screen can be generated on the larger display that is derived from or corresponds with the smartphone sales leads display screen but that also shows the same sales leads on the larger screen. The larger screen can include additional information, such as more details about the sales leads, graphics, such as bounding boxes, line connectors, color cues, controls, additional text, and so on. This modified display screen for the larger display can convey more information about the sales leads to assist a viewer to better understand the sales leads or other information on the larger display. Additional controls, such as navigation, selection controls, etc., can be provided via the larger screen display and can be selected or operated by user input on the smartphone or other small screen system.

This approach allows a user to display different, enhanced, forms of the same information normally seen in a mobile, desktop or other device to a bigger screen (e.g., from a projector or on a television, etc.) but in a different or otherwise augmented layout. The bigger layout can take advantage of or otherwise leverage richer media assets of the larger screen system to enhance displayed content. Enhanced, or merely modified, controls or other functionality or display features can be provided.

For clarity, certain well-known components, such as hard drives, processors, operating systems, power supplies, Internet Service Providers (ISPs), class loaders, bytecode compliers, and so on, are not explicitly called out in the figures. However, those skilled in the art with access to the present teachings will know which components to implement and how to implement them to meet the needs of a given implementation.

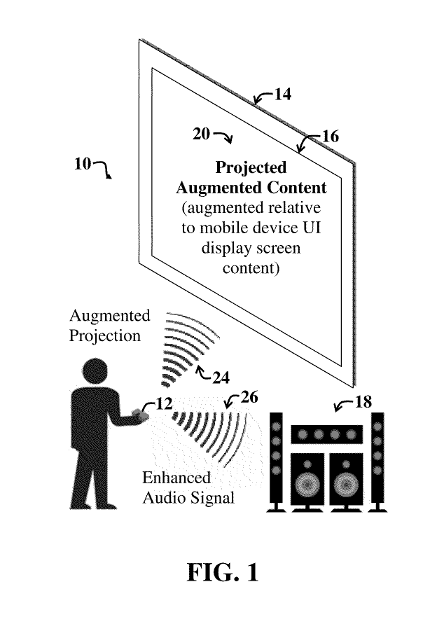

FIG. 1 is a basic pictorial diagram showing example components 12, 14, 18 of a computing environment and accompanying system 10 characterizing a first example embodiment.

For the purposes of the present discussion, a computing environment may be any collection of computing resources used to perform one or more tasks involving computer processing. A computer may be any processor in communication with a memory.

A computing resource may be any component, mechanism, or capability of a computing environment, including, but not limited to, processors, memories, software applications, user input devices, and output devices, such as displays and speaker systems. A display may be any mechanism adapted to present or otherwise illustrate or convey visual information.

For the purposes of the present discussion, a primary computing resource may be a computing device, system, or component via which a computing environment or system or behavior thereof is controlled. In FIG. 1, the mobile device 12 is considered as the primary computing resource. A secondary computing resource may be any computing resource that receives instructions and/or other information from a primary computing resource, where the second computing resource is adapted to augment, complement, or otherwise work with the primary computing resource. In FIG. 1, the secondary computing resource may be represented by or may include a projector and accompanying display screen 16.

The system 10 shows a mobile device 12 (e.g., a smartphone, tablet, laptop, etc.) with a built-in projector projecting an augmented User Interface (UI) display screen 16 on a surface 14, such as a wall. The projected UI display screen 16 presents or illustrates projected augmented content 20, which is augmented relative to content shown on a relatively small display screen of the mobile device 12.

For the purposes of the present discussion, a UI display screen may be software-generated depiction presented on a display, such as a monitor, projection surface, and so on. Examples of depictions include windows, dialog boxes, displayed tables, and any other graphical UI features, such as UI controls, presented to a user via software, such as a browser. A UI display screen contained within a single border may be called a view or window. Views or windows may include sections, such as sub-views or sub-windows, dialog boxes, graphs, tables, and so on. In certain cases, a UI display screen may refer to all application windows presently displayed on a display.

Content of a second UI display screen is said to be augmented relative to a first UI display screen if the second UI display screen includes, illustrates, or otherwise facilitates user access to additional features, e.g., data, UI controls, and/or associated functionality. The augmented content may be integrated with content from the first UI display screen or arranged separately.

For the purposes of the present discussion, content may be any information, including visual features (including visually displayed information, such as graphs, lists, UI controls, and so on), and software functionality. Software functionality may be any function, capability, or feature, e.g., stored or arranged data, that is provided via computer code, i.e., software. Generally, software functionality may be accessible via use of a UI display screen and accompanying UI controls and features. Software functionality (often simply called functionality herein) may include actions, such as retrieving data pertaining to a computing object (e.g., business object); performing an enterprise-related task, such as promoting, hiring, and firing enterprise personnel, placing orders, calculating analytics, launching certain dialog boxes, performing searches, and so on.

Content of a first UI display screen is said to be integrated with content of a second UI display screen if some content from the first UI display screen is dispersed among additional content shown in the second UI display screen. Content is said to be arranged separately if a particular region of the second UI display screen is allocated for displaying at least approximately the same or similar information as presented in the first UI display screen.

A UI control may be any displayed element or component of a UI display screen, which is adapted to enable a user to provide input, view data, and/or otherwise interact with a UI. Additional examples of UI controls include buttons, drop down menus, menu items, tap-and-hold functionality, and so on. Similarly, a UI control signal may be any signal that is provided as input for software, wherein the input affects a UI display screen and/or accompanying software application associated with the software.

The system 10 illustrates an augmented projection signal 24 comprising transmitted optical energy containing projected augmented content 20 shown in the relatively large projected UI display screen 20. Note however, that in other embodiments, the signal 24 may be an electrical signal sent via one or more wires or wirelessly (e.g., via Bluetooth, WiFi, or other mechanism), and the display 14 may represent a computer monitor, television, or other display mechanism, as discussed more fully below.

The illustrative system 10 further illustrates an enhanced audio signal 26 transmitted to an enhanced speaker system 18. The audio signal 26 may be a radio signal, e.g., Bluetooth, WiFi, cellular, infrared, etc., that is receivable and decodable by a wireless receiver of the audio system 18.

The audio signal 26 is enhanced relative to audio signals used internally by the mobile device 12 to drive relatively small speakers included in the mobile device 12. The enhanced audio signal includes additional audio information that may be used by the enhanced speaker system 18, but that may not be suitable for use with built-in speakers of the mobile device 12.

To generate the augmented projection signal 24 and the enhanced audio signal 26, the mobile device 12 first obtains information about characteristics of the display area 14 and speaker system 18. The mobile device 12 may obtain such information via manual user input; automatically through electronic interrogation, e.g., of the speaker system 18; via information from an appliance that communicates with the speaker system 18 and projector of the mobile device 12, and/or via other mechanisms, as discussed more fully below.

Hence, in general, FIG. 1 may be operated by a user through use of the mobile device 12, which represents a “smaller screen system” that may be in wireless communication with larger screen system, visually represented by the surface 14, and which may include a projector for transmitting the augmented UI display screen 16.

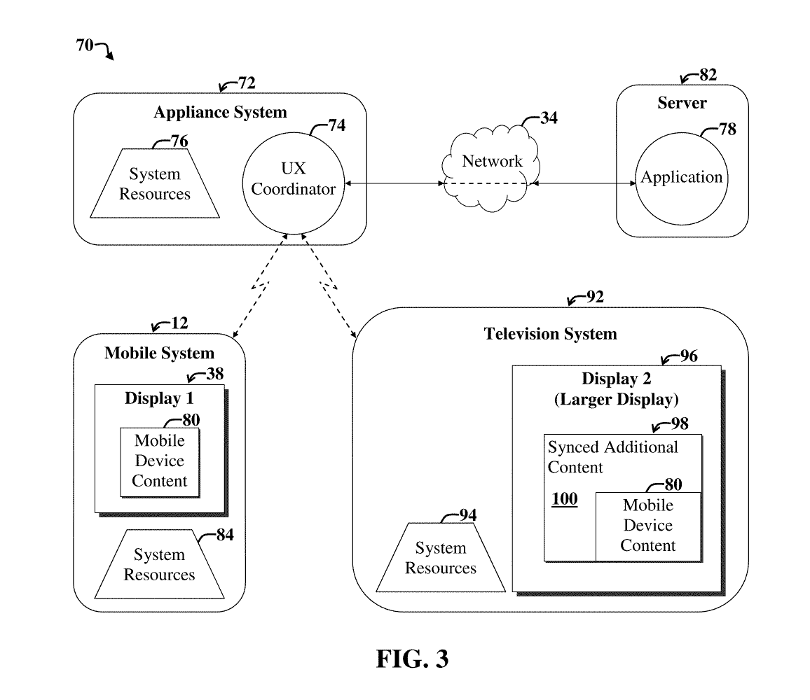

In one embodiment, instead of the projection surface 14 representing a wall or other surface, it represents a desktop computer display, television, or other electronic display that forms part of a “large screen system.” In such case, communication among the smaller screen system 12 and the larger screen system 14 may employ a “dongle” or external appliance that is plugged into a video input of the larger display of the larger screen system 14, as discussed more fully below with reference to FIG. 3.

The external appliance may receive user input signals and other communications, as desired, from smaller screen system 12. The appliance may communicate with a software application via the Internet to obtain visual data for display on both the smaller and larger screens. The data that is received is in response to the user's inputs on the smartphone.

For example, if the user is executing enterprise software to display a list of sales opportunities, then the user may navigate to a particular page in the sales application to display the list. Such a list can be rendered as a webpage on the smartphone, or as an application page or panel in a display mode tailored to the smartphone, etc.

The appliance receives the signals from input mechanisms, e.g., of the mobile device 12, and relays the signals to a server on the Internet. The server executes the sales application. The server transfers the display information to the appliance, and the appliance transfers the display information both to the television screen and to the mobile device, e.g., smartphone.

Note that the manner and format of transfer of information to the television or larger screen system and smartphone can differ greatly. In one embodiment, the appliance generates standard High-Definition Multimedia Interface (HDMI) video signals to the larger display screen or system. Accordingly, there may be no need for further processing by the larger display system itself, which can merely be a display mechanism.

The display information delivered from the appliance to the smartphone can include object information or other data structures rather than or in addition to purely image information, e.g., video information. The smaller screen system 12 may include digital processors that can derive the display or video signals from the object information.

In other embodiments, the television or other larger screen system could be a smart television, desktop computer, video projector coupled to a computing system, etc. The smaller screen system 12 could, in turn, have different levels of processing resources and in some cases can be an input/output system without requiring general or dedicated processing resources. In general, any type of processing architectures may be used for the larger and smaller screen systems, as desired.

Other embodiments are possible, e.g., embodiments that do not employ an external appliance or projected image or video. The functionality of coordinating the larger and smaller screen displays can be performed by system resources such as software and/or hardware executing wholly or partly within the larger and smaller screen systems.

Still other approaches are possible, such as by having the application and/or display system functions (including for either display screen) residing in whole or in part on any of the processing systems, such as in the smaller screen system, larger screen system, appliance, server, network device, or other remote or local device(s). Other embodiments can integrate the functions of the external appliance into one or more of the other systems or components described herein. Yet other designs are possible.

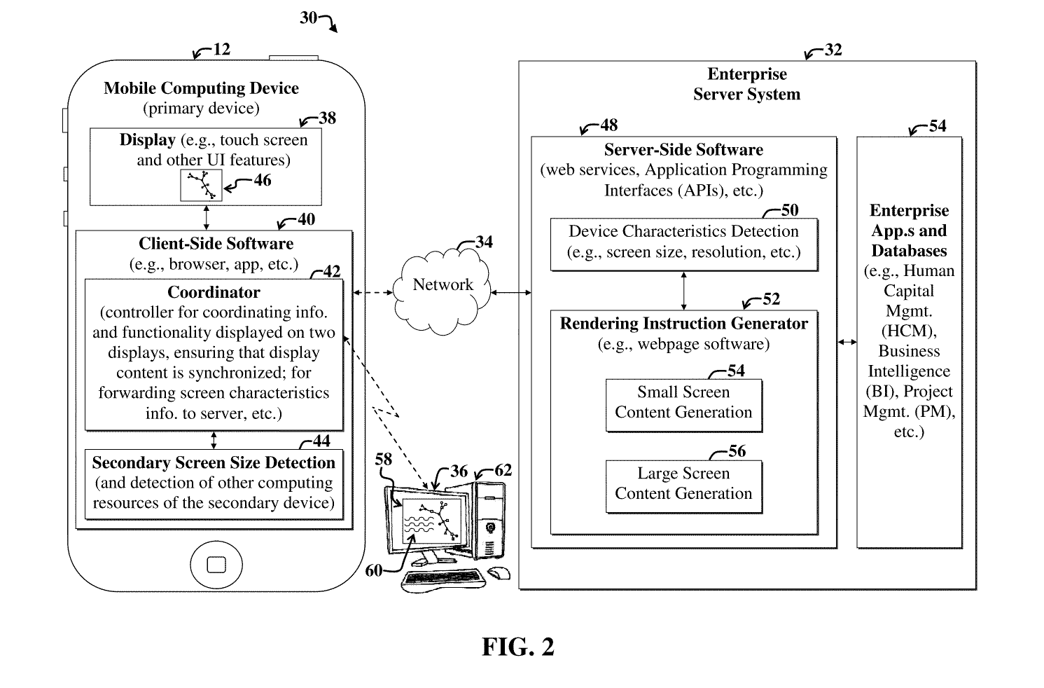

FIG. 2 shows an example enterprise computing environment and accompanying system 30 in accordance with a second embodiment for enabling use of a mobile device 12 to facilitate display of content 46 on a mobile device display 38 and enhanced or augmented content 58 on a larger display 36 of a desktop computer system 62.

For the purposes of the present discussion, an enterprise computing environment may be any collection of computing resources of an organization (e.g., company, university, government, or other organization) used to perform one or more tasks involving computer processing. An example enterprise computing environment includes various computing resources distributed across a network and may further include private and shared content on intranet web servers, databases, files on local hard discs or file servers, email systems, document management systems, portals, and so on.

Note that, in general, groupings of various modules of the system 10 are illustrative and may vary, e.g., certain modules may be combined with other modules or implemented inside of other modules, or the modules may otherwise be distributed differently (than shown) among a network or within one or more computing devices, without departing from the scope of the present teachings.

The example system 30 includes the mobile device 12, i.e., smaller screen system, in communication with a server system 32 via a network 34, such as the internet. The mobile device 12 further communicates with the desktop computer system 62, i.e., larger screen system, e.g., via a wireless or wired signal and/or via another network 34, such as the Internet.

For the purposes of the present discussion, a server system may be any collection of one or more servers. A server may be any computing resource, such as a computer and/or software that is adapted to provide content, e.g., data and/or functionality, to another computing resource or entity that requests it, i.e., the client. A client may be any computer or system that is adapted to receive content from another computer or system, called a server. A Service Oriented Architecture (SOA) server may be any server that is adapted to facilitate providing services accessible to one or more client computers coupled to a network.

The example server system 32 further includes server-side software 48, e.g., webpage software, which may include web services, Application Programming Interfaces (APIs), and/or other mechanisms for enabling communications with backend enterprise databases, e.g., Human Capital Management (HCM), Project Management (PM), and/or other databases.

The server-side software 52 further includes a rendering instructions generator 52, which includes a small screen content generator 54 that includes computer code for generating rendering instructions rendering UI display screens on relatively small screens, and a large screen content generator 56 that includes computer code for generating rendering instructions for relatively large screens. For the purposes of the present discussion, rendering instructions may be any computer code that specifies information usable by a display mechanism to present visual information or other content via the display mechanism.

A device characteristics detection module 50 is adapted to determine and store or otherwise maintain information about computing resources of different devices for which content will be served. For example, device characteristics may include information pertaining to display sizes, dimensions or aspect ratios (e.g., form factor information) of different displays, information describing speaker system capabilities, and so on.

In the present example embodiment, the server-side device characteristics detection module 50 is populated with information about computing resources of the mobile device 12 and the desktop computer system 62, via client-side software 40 running on the mobile device 12. The mobile device 12 includes a display 38, which may illustrate mobile device content 46 derived from the small screen content generator 54 of the server-side software.

The mobile device display 38 (also called the smaller display) communicates with client-side software 40, which includes a coordinator 42 for coordinating delivery of rendering instructions (e.g., from the small screen content generator 54 and the large screen content generator 56) between the mobile device display 38 and the desktop display 36 (also called the larger display) of the desktop computer system 62. The coordinator 42 may act as a controller for coordinating information and functionality 46, 58 displayed on the mobile device display 38 and the desktop display 36, while ensuring that displayed content 46, 58 is synchronized, and for forwarding screen information specifying characteristics and/or other computing resource information (e.g., specifications) to the server-side software 48.

For the purposes of the present discussion, a first display and/or accompanying UI display screen is said to be coordinated with a second display and/or accompanying UI display screen if content and/or functionality presented by the two displays is synchronized, or a context information is otherwise maintained. Coordinated content may include content derived from similar sources or a single source, e.g., a single software application (e.g., server-side software) and/or one or more databases 54.

Hence a first UI display screen is said to be coordinated with a second UI display screen if content presented thereby is coordinated, e.g., synchronized or otherwise adjusted in accordance with an awareness of or information pertaining to what is displayed on the other screen.

The example client-side coordinator 40 communicates with a server-side secondary screen size detection module 44. In the present example embodiment, the secondary screen size detection module 44 includes computer code for interrogating (or otherwise receiving information from) the desktop computer system 62 to determine characteristics of the desktop display 36 (e.g., form factor, resolution, refresh rate, etc.) that will then affect how content is rendered thereon and will affect large screen content generation 56 accordingly.

The secondary screen size detection module 44 may also include computer code for facilitating determining other computing resource characteristics, such as performance characteristics or parameters of peripheral devices, e.g., speakers, of the desktop computer system 62. The other computing resources may be leveraged to provide enhanced user experience relative to that provided by the mobile device 12 alone. Information gathered by the secondary screen size detection module 44 may be forwarded to the client-side coordinator 42, which may then forward the information to the device characteristics detection module 50 of the server-side software 48.

Alternatively, or in addition, the secondary screen size detection module 44 may generate rendering instructions for the mobile device display 38 to enable a user to manually specify and/or edit characteristics of the desktop computer system 62 and accompanying resources, e.g., desktop display 36.

In an example scenario, a user employs the mobile device 12 and accompanying client-side software 40 to browse to a website, which runs the server-side software 48. The server-side device characteristics detection module 50 detects characteristics of the mobile device 12, e.g., which plugins are available, capabilities and characteristics of the display 48, which type of device the mobile device 12 is, and so on. This information is then used by the small screen content generation module 54 to generate rendering instructions for generating a UI display screen and associated content 46 for the server-side software and associated website for display on the mobile device display 38.

In accordance with the present scenario, the mobile device 12 then establishes communications with the desktop computer 62. The client-side secondary screen size detection module 44 then determines capabilities and characteristics of the desktop display 36. This information about the desktop display 36 is forwarded, via the client-side coordinator 42, to the device characteristics detection module 50.

The server-side rendering instruction generator 52 then employs the large screen content generator 56 to generate enhanced or augmented rendering instructions (or additional instructions for controlling or using other desktop computer resources, e.g., speaker systems, etc.). The augmented rendering instructions are then returned to the coordinator 42, which delivers the augmented instructions to the desktop computer 62 for rendering on the display 36 thereof.

In the present example embodiment, the mobile device display 38 shows example rendered mobile content 46, while the desktop display 36 shows example rendered augmented content 58, which includes additional content 60 that is not shown in the mobile device display 38.

Note that implementation of certain embodiments may not require use of a server or server system. For example, the server-side software 48 and data sources 54 may be implemented client-side, e.g., on the mobile device 12, without departing from the scope of the present teachings.

FIG. 3 shows an example system 70 in accordance with a third embodiment usable with the embodiment of FIG. 1 and employing an appliance 72 (also called an appliance system), such as a set-top box, to facilitate coordinating content delivery to a mobile device 12 and television system 92 in accordance with computing resources of each system or characteristics thereof, e.g., display size.

For the purposes of the present discussion, an appliance may be any device, e.g., embedded device, in communication with one or more other devices of a computing environment, and which is usable for a relatively specialized function as compared to one or more other devices of the computing environment.

In general, an embedded device may be any device, e.g., home appliance, sensor, and so on, which is coupled to or otherwise adapted to communicate with a computer. Such devices are often called smart devices or smart appliances, and may include wired or wireless communication mechanisms, such as Bluetooth, Wireless Fidelity (WiFi), or Near Field Communication (NFC) transceivers, and so on.

A home appliance may be any device or sensor that is adapted for use in or on proximity to a home. Similarly, a smart home appliance may be a home appliance that includes processing capabilities sufficient to relay information to and/or receive information from another device, such as a computer system or controller.

Accordingly, certain smart home appliances may include computers and communication mechanisms, such that the smart home appliances act as embedded devices, which may be embedded in a larger computing environment that includes a remotely coupled computer, such as a controller.

The appliance 72 may represent an embedded device that acts as a home appliance gateway. For the purposes of the present discussion, a gateway may be any system that is adapted to facilitate routing information between connected devices. A smart gateway may be any gateway that includes a computer system and accompanying software for facilitating communications between devices or other systems. Smart gateways, as discussed herein, may further facilitate routing data and control signaling between devices to facilitate coordinating or controlling features and/or accompanying behaviors of devices or systems coupled to the smart gateway system.

The appliance 72 may be implemented via a set-top box. A set-top box may be any appliance that includes a television tuner input and output that is coupled to a television set or display thereof and that further includes content input, e.g., from a server system or other rendering instruction generation mechanism, where the content is then displayable on the television display.

In the present example embodiment, the appliance 72 includes appliance system resources 76 in communication with a User eXperience (UX) coordinator 74. The UX coordinator 74 communicates with a server-side application 78 of a server 82 via a network 34, such as the Internet. The UX coordinator 74 further communicates with a mobile device 12 (also called mobile system) and a television 92 (also called a television system).

The UX coordinator 74 is adapted to selectively deliver a first set of information 80 (i.e., mobile device content) to mobile system resources 84 of the mobile system 12 for presentation on the display 38 thereof. The UX coordinator 74 is further adapted to selectively deliver a second set of information 98 (i.e., television screen content) to system resources 94 of the television 92 for presentation on the larger display 96 thereof.

The second set of information represented by the larger screen content 98 is augmented relative the mobile device content 80 to the extent that additional content 100 is presented on the larger display 96. The additional content 100 may be synchronized with the mobile device content 80, such that changes in mobile device content 80 may result in corresponding adjustments to the additional content 100.

For the purposes of the present discussion, a set of information may be any collection of data and/or computer instructions, which may include instructions for facilitating implementing functionality of a software application and may include instructions and data for rendering a UI display screen and presenting or displaying visual information and other content of the UI display screen. Visual information may be any data that is or can be presented pictorially or graphically or that is or can otherwise be readily viewed.

A second set of information is said to overlap a first set of information if the first set of information represents a subset of the second set of information. Similarly, content presented on two different displays is said to include overlapping visual information if information on a first display shares at least some similar information as displayed on a second display.

Certain embodiments are not limited to presenting augmented or additional content on a larger display, where the additional content is synchronized with the mobile device content also displayed via the larger display. For example, in one implementation, the mobile device content 80 includes an arrangement of icons or other UI controls for a given application or operating system. In this case, the additional content 100 may include substantially unrelated or otherwise non-synchronized content, e.g., a news feed, a blog, and so on.

Hence, FIG. 3 shows additional details of example workings of an example system usable with the system 10 of FIG. 1, where the mobile device 12 represents a “smaller screen system” that and has its own resources 84, such as device hardware and physical controls, applications, utilities, operating system features, etc. The smaller screen system 12 communicates with the UX coordinator 74 and accompanying process resident in the appliance system 72.

In one embodiment, the appliance system 72 is incorporated into a “dongle” that is a small external component that can attach to an HDMI or other typical connector such as USB, Ethernet, etc. As described above, the appliance system 72 includes its own resources 76 and communicates with the television system 92, which represents a “larger screen system” in this example. The larger screen system 92 includes its own system resources 94, which can be used to implement the various features described herein.

The UX coordinator 74 communicates with an application, such as the server-side application 78, via the network 34. The application 78 is executed by the server 82, which allows the user to run the application 78 (or to otherwise access and instance thereof) via the smaller or larger screen systems 12, 92.

Note that any number of server computers or other computing systems can be used to provide the application functionality. Each server computer typically includes its own resources and has access to additional external resources (not shown). In different embodiments, the application software 78 may be executed in whole or in part on any of the other devices having computing resources such as the appliance system 72, television system (larger screen system) 92, or mobile system 12 (smaller screen system).

In an example specific embodiment, the appliance system 72 implements the UX coordinator 74 as a web client having a single session with the server-side application 78. The server-side application 78 largely mimics a desktop client experience but can be adapted especially to implement extended screen features.

The appliance system 72 can use JavaScript Object Notation (JSON) and web sockets for communications with the mobile system 12. In this manner, the UX coordinator 74 controls both displays 38, 96. Synchronization or coordination of the two displays 38, 96 is known by controlling code at one location. In other embodiments, there can be multiple sessions; parts of the application can execute locally; screen coordination can be handled independently by resources of the smaller and larger screen systems 12, 92 (e.g., in response to broadcast messages, etc.); or in other ways.

In a particular embodiment, a custom native UI running on the mobile system 12 uses information provided by the UX coordinator 74 to generate the smaller UI display screens (also called the smaller screens) corresponding to the mobile content 80. The smaller screens are designed to closely resemble any mobile application UI display screens and controls with which the user may already be familiar.

In other implementations, the smaller screen system 12 can be running the actual mobile application and have an active session directly with the application software 78 or indirectly through an appliance system, e.g., the appliance system 72, or with another device or process. Many variations are possible and may be within the scope of the claims.

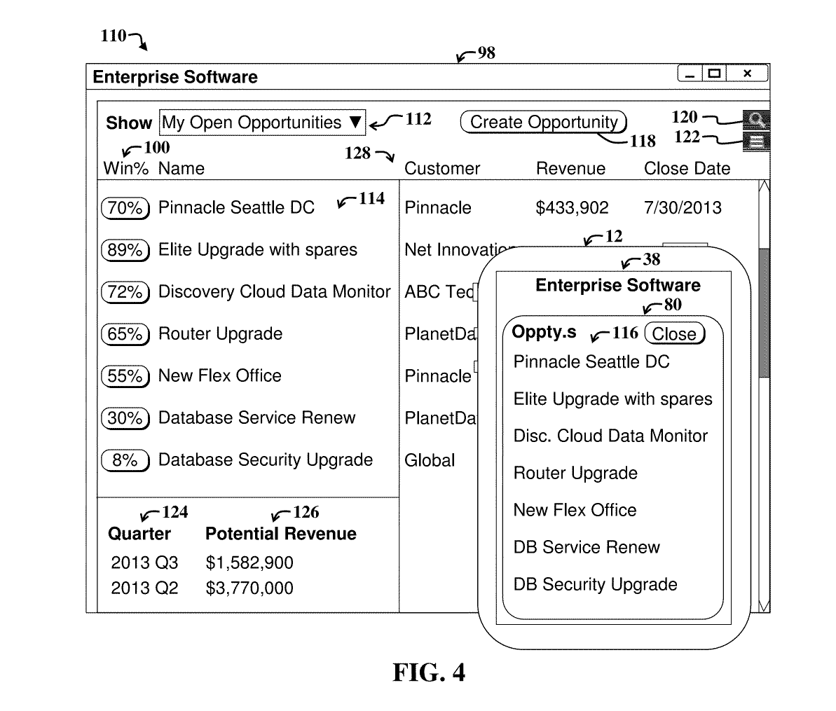

FIG. 4 shows a first set of UI display screens 110, including a smaller UI display screen 80 coordinated with a larger UI display screen 98. The larger UI display screen 98, as may be presented on a larger display, e.g., the display 96 of FIG. 3 (or the display 36 of FIG. 2 or the display 14 of FIG. 1), includes augmented and/or reformatted content 100, 112, 118-128 relative to the smaller display 38.

The example mobile device 12 (and accompanying display 38 and displayed UI display screen 80) is juxtaposed with the larger UI display screen 98 (also called the second UI display screen herein).

In the present example embodiment, the mobile UI display screen 80 includes an example listing 116 showing names of enterprise opportunities derived via an enterprise software application employing the mobile device screen 38. The listing 116 represents mobile device content, also called smaller screen content.

The mobile device content 116 is also presented on the larger UI display screen 98, e.g., via a corresponding listing 114. However, the larger UI display screen 98 has been reformatted to show or otherwise facilitate user access to additional content and functionality, such as opportunity win percentage 100, a table 128 of associated customers, revenue, and close date corresponding to each opportunity of the listings 114, 116, and so on, as discussed more fully below.

The example additional content 100, 112, 118-128 further includes various UI controls that are not shown in the mobile UI display screen 80. For example, the additional content 100, 112, 118-128 and associated functionality includes a drop-down menu 112 for switching the UI display screen 98 to show different or updated content; a create-opportunity button 118 adapted to facilitate enabling a user to add an opportunity to the listings 114, 116; a search button 120 adapted to enable a user to initiate display of a query field and associated search options to search for opportunities or related information; a side-bar control 122 for enabling display of more UI controls and/or content; a listing showing potential revenue 126 by quarter 124 for a particular selected opportunity, and so on.

Note that the larger UI display screen 98 exhibits a different UI architecture than that exhibited by the smaller UI display screen 80. Nevertheless, the different UI display screens 98, 80 may represent renderings derived from the same underlying software application.

For the purposes of the present discussion, a rendering may be any computer instructions or information suitable for determining one or more visual features and associated functionality that are adapted to be displayed via a UI display screen. Accordingly, a file that includes information that is displayable via a browser or other application UI may include a “rendering.” Similarly, the actual visual information displayed in a UI display screen may also be called a rendering. Depending upon the context, the term “rendering” may be taken to include just the visual aspects of a UI display screen and/or underlying instructions used to generate the UI display screen or features thereof, or may further include functionality associated with the displayed features.

In general, as the term is used herein, a rendering of a software application may include a UI architecture (or representations or characterizations thereof) associated with the software application. A UI architecture may be any framework or set of rules or guidelines employed to render a UI display screen or portion thereof. A UI architecture may, for example, specify a method and/or organization (e.g., organization of UI controls and associated functionality) for enabling or facilitating user interaction with a software application.

The terms “UI architecture” and “UI framework” may be employed interchangeably. However, a UI framework, as the term is used herein, may further include any descriptions and accompanying computer code for rendering a UI display screen in accordance with a set of criteria specifying how components of a UI display screen are to be characterized, e.g., sized, positioned, shaped, validated, and so on.

Note that, for the purposes of the present discussion, a UI display screen may be different than a rendering, to the extent that a UI display screen is used to illustrate a rendering, but a rendering may exist regardless of whether it is displayed via a UI display screen.

In general, different UI architectures, e.g., architectures characterizing the larger UI display screen 98 and the smaller UI display screen 80, may be characterized by different content formats. For example, content 116 of the mobile UI display screen 80 may be integrated with (or otherwise blended with or interspersed among) other additional or different content in the larger UI display screen 98.

A given UI architecture (and associated UI display screen rendering) is characterized by a particular format, i.e., arrangement of content elements associated therewith. Accordingly, the format or layout of the larger screen 98 is said to be different, i.e., adjusted, relative to the smaller display screen 80 to facilitate efficient accommodation of additional content 100, 112, 118-128 and accompanying functionality afforded by the larger screen space or otherwise afforded by different computing resources or capabilities associated with the larger UI display screen 98. The terms “format,” “layout,” and “content arrangement” may be employed interchangeably herein.

Hence, in summary, FIG. 4 shows an example smaller UI display screen 80 coordinated with a larger UI display screen 98. The smaller UI display screen 80 shows a list 116 of opportunity names under the heading “Opportunities.”

The larger UI display screen 98 shows the same or similar list 114 (as the list 116) with additional information, such as the probability of a “win” as “Win %” in the a left column (which may include color keying). Additional columns of information 128, such as “Customer,” “Revenue,” “Close Date” and “Sales Stage” are included, whereas there is insufficient room to accommodate these columns 128 in the smaller UI display screen 80 and associated display 38.

Other information is included in the larger UI display screen 98, such as the particular quarter 124 that the data applies to (“Quarter 3, 2013”), the search or selection criteria (provided via the drop-down menu 112) for the list (“My Open Opportunities”), “Potential Revenue,” 126, and so on. Other additional controls are shown in the larger UI display screen 98, such as the “search” and “sidebar” buttons 120, 122, which are at the far right of the larger UI display screen 98. These buttons 120, 122 are absent from the smaller UI display screen 80 presented on the smaller mobile device display 38.

Note that additional controls not shown in the smaller UI display screen 80, e.g., additional navigation, selection, editing or other controls can be provided in the larger UI display screen 98. These controls can be activated from the smaller UI display screen 80 as, for example, by allowing a pointer on the larger UI display screen 98 to be controlled by a touch screen display 38 of the mobile device 12.

Alternatively or in addition, hardware buttons on the mobile device 12 can be used along with any other suitable user input control such as sliders, dials, gesture detection, image detection, voice or sound commands, etc., for the purposes of interacting with the larger UI display screen 98 and/or the smaller UI display screen 80.

The added or enhanced functionality of the larger UI display screen 98 need not be limited to visual output and UI controls. For example, if the larger screen system (which provides the larger UI display screen 98) has a 5.1 speaker configuration, and the smaller screen system, i.e., mobile device 12, only has stereo, then the audio can be enhanced for playback through the larger screen system's speaker system. Other features, such as contrast control, graphics processor (for faster rendering of 3D models or animation), resident applications, utilities or operating system features, etc. can be used when a display or function on the smaller screen system is used to coordinate with the larger screen system.

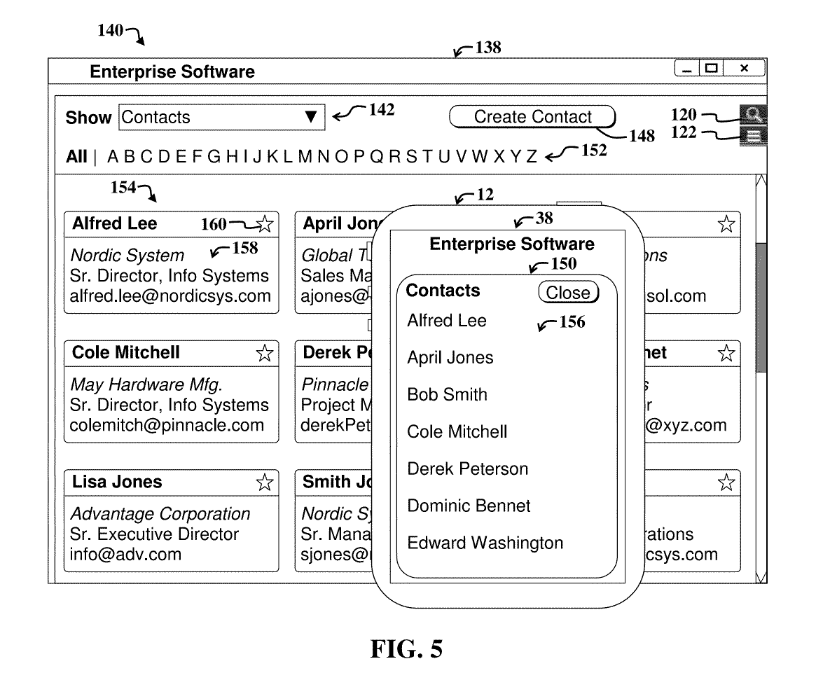

FIG. 5 shows a second set of UI display screens 140, including a UI display screen 150 of a smaller display 38, which is coordinated with a larger UI display screen 138 of a larger display.

The example UI display screen 150 of the mobile device 12 includes a listing of contact names 156. In the larger UI display screen 138, the contact name content 156 is integrated with additional information 158 that is provided in various tiles 154 corresponding to contacts represented in the mobile UI display screen listing 156. For the purposes of the present discussion, content is said to be integrated with other content if the content is visually dispersed among the other content.

The example larger UI display screen 138 shows additional content (in addition to the added content 158) pertaining to each content name provided in the list 156 of the mobile device UI display screen 150. The additional content includes an alphabetical contact selector 152, which is adapted to provide a user option to transition or change illustrated or presented content to a presentation of contact information characterized by contact names that begin with a selected letter. A create contact button 148 is adapted to provide one or more user options to specify (e.g., name) a new contact and associated information.

In summary, FIG. 5 shows smaller and larger UI display screens 150, after a user has navigated to a “Contacts” page via the smaller UI display screens 150, 138. Note that although the present discussion herein is with respect to the smaller screen system 12 (e.g., mobile device), which is used as a controlling or coordinating device, it is also possible to have inputs associated with or implemented by the larger screen system used to control the UI display screen 138 or other functions provided via the smaller UI display screen 150 of the smaller screen system 12.

In FIG. 5, the larger UI display screen “Contacts” are brought up at the same point in the contacts 154 as where the user is viewing contacts 156 on the smaller display 38. The user can navigate to the contacts UI display screen 150 by using controls provided on the display 38 of the mobile device 12, or on the handset of the physical mobile device, e.g., smartphone, tablet, laptop, etc. Any acceptable form of input can be used to allow the user to use the smaller screen system to perform navigation.

As the user navigates among UI display screens in the smaller screen system 12, the larger UI display screen 138 of the larger screen system changes accordingly to maintain a correlation of what the user is viewing on the smaller UI display screen 150 with the information displayed on the larger UI display screen 138.

In a particular implementation, for each change in the smaller UI display screen 156, a corresponding or associated change in the larger UI display screen 138 will occur, and vice versa. This type of synchronization can include changing of a panel or page that is being viewed, or merely re-positioning of the focus or starting information on the larger UI display screen 138 in accordance with the start of information on the smaller UI display screen 150.

In FIG. 5, in the larger UI display screen 138, there is enough room to display each contact name via a tile, i.e., information card, rather than just the name, itself. Other controls are shown in the larger UI display screen 138, such as the alphabet selection bar 152 near the top of the UI display screen 152. In another example, star buttons 160 on the information cards 154 enable user marking of the card/person as a “favorite” or providing it with elevated status, etc.

As with the first set of UI display screens 110 shown in FIG. 4 and the second set of UI display screens 140 of FIG. 5, a user of the smaller screen system 12 can have access to the controls on the larger screen system by using the smaller screen system display 38 and/or associated input/output devices or other UI mechanisms.

In the present example embodiment, a user can use a touch screen display 38 of the mobile device 12 as if the UI display screen 150 shown in the touch screen display 38 is mapped to a larger UI display screen of a television, desktop computer, projector and accompanying surface, or other mechanism. For example, the user can position a cursor on a television display screen by touching or swiping a finger across the mobile device touch screen display 38. The position and behavior of the cursor on the television display screen would follow analogous positioning and movement of the touches, swipes or other actions on the smaller display.

Note that while specific examples of augmented content illustrated on a larger display relative to a smaller display are shown and discussed herein, embodiments are not limited to the specific arrangements or types of additional content presented via the different displays. For example, a “home page” or “desktop” view of an application UI may be shown on both smaller and larger displays, where application icons are arranged in a larger grid (3×4 instead of 3×3) on the larger UI display screen, enabled by extra available display space on the larger display. In this case, the larger UI display screen may also provide additional “sidebar” information, e.g., in the form of the “News” section. The selection and arrangement of additional information on the larger UI display screen can be by default settings in the UX coordinator, or can be by user selection or other means.

In certain implementations of embodiments discussed herein, it is possible for a user to customize or modify the behavior of the UX coordinator (e.g., the UX coordinator 74 as shown in FIG. 3) and how the correlation of large UI display screen information occurs with respect to the small UI display screen information selected by the user.

In general, the re-arrangement of screen objects such as icons or other visual elements can be under the control of a UX coordinator that executes externally from the smaller and larger screen systems, as described above in more detail with reference to FIG. 3. The UX coordinator can handle all or a portion of the functionality needed to implement features described herein and can be implemented among any of the available hardware and/or software resources.

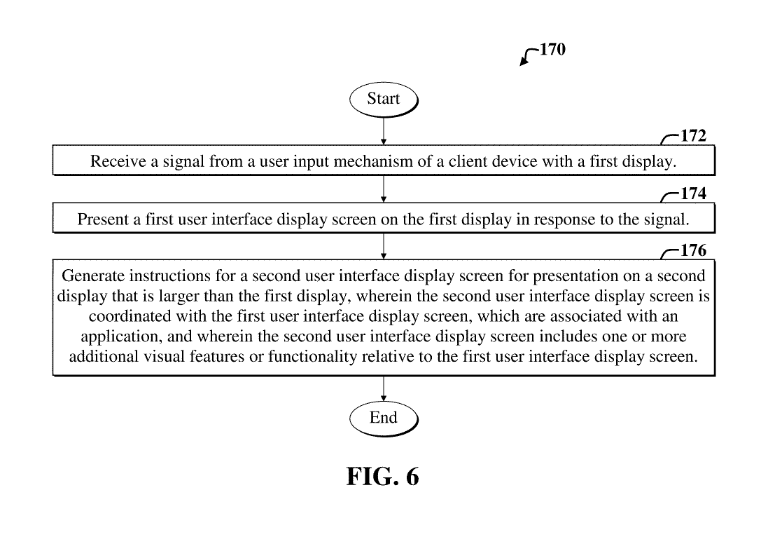

FIG. 6 is a flow diagram of a first example method 170 that is adapted for use with the embodiments of FIGS. 1-5. The first example method 170 is adapted to facilitate levering computing resources to convey or illustrate information in a computing environment.

The first example method 170 includes an initial receiving step 172, which involves receiving a signal from a user input mechanism of a client device, such as a smartphone in communication with a server. The client device client device is characterized by the user input mechanism in communication with a first display, e.g., a touchscreen display.

A subsequent presentation step 174 includes displaying a first UI display screen on the first display in response to the signal.

A third instruction-generating step 176 includes generating instructions for a second UI display screen for presentation on a second display that is larger than the first display, wherein the second UI display screen is coordinated with the first UI display screen. The first and second UI display screens are associated with or otherwise derived via a common application. The second UI display screen may include one or more additional visual features or functionality relative to the first UI display screen, such as one or more additional UI controls, information listings, and so on, which may not be present on the smaller first UI display screen.

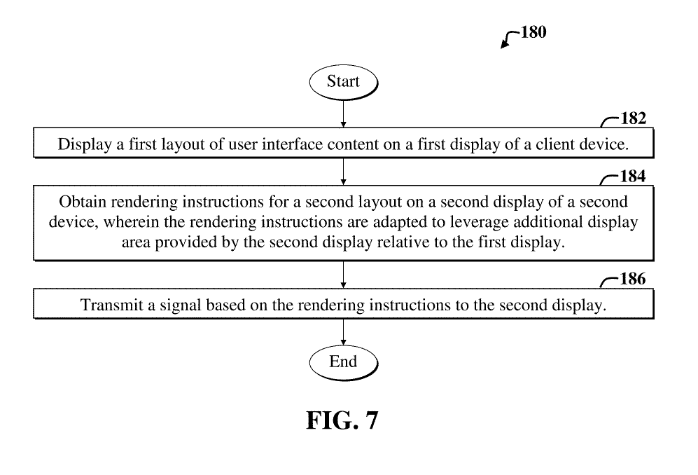

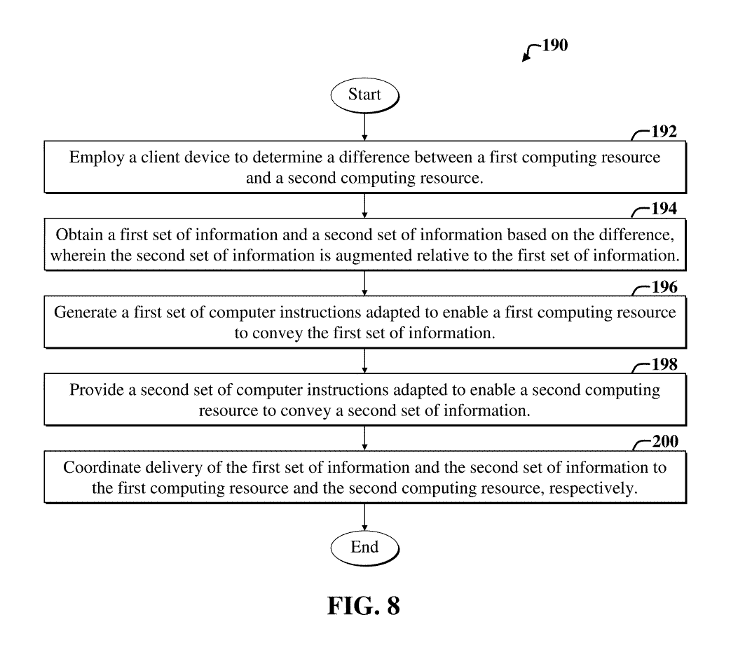

Note that the method 170 is illustrative and may be modified, e.g., steps may be changed, added, and/or removed, without departing from the scope of the present teachings. Examples of different methods are discussed more fully below with reference to FIGS. 7 and 8.

FIG. 7 is a flow diagram of a second example method 180 that is adapted for use with the embodiments of FIGS. 1-6. The second example method 180 includes a first displaying step 182, which involves displaying a first layout on a first display of a client device.

The first layout represents a first arrangement of content on the client device, e.g., mobile device in communication with a server. The first arrangement of content may be in accordance with a first UI display screen architecture adapted for use with relatively small devices, e.g., smartphones.

A subsequent instruction-obtaining step 184 includes obtaining rendering instructions for a second layout on a second display of a second device. The rendering instructions are adapted to leverage additional display area provided by the second display relative to the first display. The second layout represents a second arrangement of content in accordance with a second UI display screen architecture that is adapted for use with the larger display.

Next, a transmitting step 186 includes transmitting a signal based on the rendering instructions to the second display.

The method 180 may be modified without departing from the scope of the present teachings. For example, the method 180 may further include coordinating a first UI display screen characterized by the first layout with a second UI display screen characterized by the second layout. The second UI display screen may include one or more additional visual features or functionality relative to the first UI display screen.

For example, the second UI display screen may include at least one additional UI control that is not present in the first UI display screen. The second layout presented by the second display may present additional information relative to information displayed via the first layout via the first display.

The method 180 may be further modified or augmented to include presenting the second layout as a projection from a projector. The first layout and the second layout may be associated with a single application that is adapted to transfer rendering instructions for the first layout and the second layout to the client device and to a device characterized by the second display, e.g., a television system.

FIG. 8 is a flow diagram of a third example method 190 that is adapted for use with the embodiments of FIGS. 1-7. The third example method 190 includes a first step 192, which involves employing a client device to determine a difference between a first computing resource and a second computing resource.

A second step 194 includes obtaining a first set of information and a second set of information based on the difference, wherein the second set of information is augmented relative to the first set of information.

A third step 196 includes generating a first set of computer instructions adapted to enable a first computing resource to convey the first set of information.

A fourth step 198 includes providing a second set of computer instructions adapted to enable a second computing resource to convey a second set of information.

A fifth step 200 includes coordinating delivery of the first set of information and the second set of information to the first computing resource and the second computing resource, respectively.

Note that the third example method 190 may modified without departing from the scope of the present teachings. For example, in certain implementations all content shown via different display screens or other computing resources need not be coordinated between the different displays or other resources. For example, a news feed or blog shown on a larger UI display screen of a larger display system need not be coordinated with content shown on a smaller UI display screen of a smaller display system, e.g., mobile device.

The method 190 may be further augmented or modified by specifying that the first computing resource includes a first display, and the second computing resource includes a second display that is larger than the first display. The difference represents a difference in viewable display areas between the first display and the second display. The first set of information and the second set of information may include overlapping visual information

The client device may include or represent an appliance, or the appliance may otherwise act as a client device to an application running on a server. The appliance may communicate with the first computing resource and the second computing resource, where the first computing resource characterized by the first display, and the second computing resource characterized by a second display that is larger than the first display.

The appliance may include or represent a set-top box. The first computing resource may include a mobile device display. The client device may include a mobile device that is adapted to transmit rendering instructions to the second display. The rendering instructions may be adapted to leverage additional display area of the second display relative to the display area of the first display.

The first computer instructions and the second computer instructions may include or represent rendering instructions from a single software application.

Alternatively, or in addition, the first set of information may include information contained in a first audio signal tailored for use by the first computing resource. Similarly, the second set of information may include information contained in a second audio signal tailored for use by the second computing resource. A second speaker system includes additional functionality relative to a first speaker system, wherein the additional functionality is adapted to use additional information contained in the second audio signal relative to the first audio signal.

Note that various additional or different methods are possible. For example, another method includes determining one or more primary computing resources of primary computing device; generating a first signal in response to determining; detecting one or more auxiliary computing resources of a secondary computing device; generating a second signal in response to detecting; using the first signal to generate computer code for leveraging the primary computing resources; and employing the second signal to generate computer code for leveraging the one or more auxiliary computing resources. The primary computing resources may include a mobile device display, and the auxiliary computing resources may include, for example, a desktop display.

Although the description has been described with respect to particular embodiments thereof, these particular embodiments are merely illustrative, and not restrictive. For example, while various embodiments discussed herein refer to utilizing additional screen real estate of a larger display to display additional information relative to a coordinated smaller display, embodiments are not limited thereto. For example, certain embodiments discussed herein may be employed to leverage enhanced computing resources other than displays, such as computer processing capabilities afforded by a different computing system. More capable computer processing characteristics of a desktop display may be leveraged to perform additional complex calculations, which may be synchronized with and may augment calculations performed on a less capable mobile device or other platform.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for coordinating the display of an application across multiple display screens in a computing environment, the computing environment including one or more computing devices in communication with a software application, wherein the software provides displayable information accessible to the one or more computing devices, a computing device of the one or more computing devices executing the steps of the method, the method comprising:
receiving a signal from a user input mechanism of a first device, the first device characterized by the user input mechanism in communication with a first display;
displaying a first user interface display screen on the first display in response to the signal; and
generating instructions for a second user interface display screen for presentation on a second display that is larger than the first display, wherein the second user interface display screen is coordinated with the first user interface display screen, wherein the first user interface display screen and the second user interface display screen are associated with a software application, and wherein the second user interface display screen includes one or more additional features relative to the first user interface display screen.

2. The method of claim 1, further including:
employing a client device to determine a difference between a first computing resource and a second computing resource;
obtaining a first set of information and a second set of information based on the difference, wherein the second set of information is augmented relative to the first set of information;
generating a first set of computer instructions adapted to enable a first computing resource to convey the first set of information;
providing a second set of computer instructions adapted to enable a second computing resource to convey a second set of information;
coordinating delivery of the first set of information and the second set of information to the first computing resource and the second computing resource, respectively.

3. The method of claim 2, wherein the first computing resource includes the first display, and the second computing resource includes the second display.

4. The method of claim 3, wherein the difference represents a difference in viewable display areas between the first display and the second display.

5. The method of claim 3, wherein the first set of information and the second set of information include overlapping visual information.

6. The method of claim 5, wherein the client device includes an appliance, and wherein the appliance is in communication with the first computing resource and the second computing resource.

7. The method of claim 6, wherein the appliance includes a set-top box, and wherein the first computing resource includes a mobile device display.

8. The method of claim 5, wherein the client device includes a mobile device that is adapted to transmit rendering instructions to the second display, wherein the rendering instructions are adapted to leverage additional display area of the second display relative to the display area of the first display.

9. The method of claim 2, wherein the first computer instructions and the second computer instructions include rendering instructions derived from output of a single software application.

10. The method of claim ,2 wherein the first computing resource includes the first display, and wherein the second computing resource includes the second display that is larger than the first display, and wherein the first set of information includes visual information adapted for presentation of a first user interface display screen on the first display, and wherein the second set of information includes visual information adapted for presentation on a second user interface display screen on the second display.

11. The method of claim 10, wherein the second user interface display screen represents a reformatted version of the first user interface display screen.

12. The method of claim 10, wherein the second user interface display screen includes information present in the first user interface display screen that is integrated with additional information not present in the first user interface display screen.

13. The method of claim 10, wherein the second user interface display screen includes one or more additional user interface controls relative to the first user interface display screen.

14. The method of claim 2, wherein the first computing resource includes a first speaker system, and wherein the second computing resource includes a second speaker system.

15. The method of claim 14, wherein the first set of information includes information contained in a first audio signal tailored for use by the first computing resource, and wherein the second set of information includes information contained in a second audio signal tailored for use by the second computing resource.

16. The method of claim 15, wherein the second speaker system includes additional functionality relative to the first speaker system, and wherein the additional functionality is adapted to use additional information contained in the second audio signal relative to the first audio signal.

17. The method of claim 2, wherein the first computing resource includes a mobile device display showing the first user interface display screen, and wherein the second computing resource includes a projector adapted to project the second user interface display screen.

18. The method of claim 17, wherein the first user interface display screen is characterized by a first layout, and wherein the second user interface display screen is characterized by a second layout that includes one or more user interface controls not present in the first user interface display screen.

19. An apparatus for coordinating the display of an application across multiple display screens in a computing environment, the computing environment including one or more computing devices in communication with a software application, wherein the software application executes software, wherein the software provides displayable information accessible to the one or more computing devices, the one or more computing devices configured to perform the following acts:
receiving a signal from a user input mechanism of a first device, the first device characterized by the user input mechanism in communication with a first display;
displaying a first user interface display screen on the first display in response to the signal; and
generating instructions for a second user interface display screen for presentation on a second display that is larger than the first display, wherein the second user interface display screen is coordinated with the first user interface display screen, wherein the first user interface display screen and the second user interface display screen are associated with an application, and wherein the second user interface display screen includes one or more additional visual features or functionality relative to the first user interface display screen.

20. A tangible storage medium including instructions executable by one or more servers of a server system for coordinating the display of an application across multiple display screens in a computing environment, the computing environment including one or more computing devices in communication with a software application, wherein the software application executes software, wherein the software provides displayable information accessible to the one or more computing devices, the tangible storage medium including instructions for:
receiving a signal from a user input mechanism of a first device, the first device characterized by the user input mechanism in communication with a first display;
displaying a first user interface display screen on the first display in response to the signal; and
generating instructions for a second user interface display screen for presentation on a second display that is larger than the first display, wherein the second user interface display screen is coordinated with the first user interface display screen, wherein the first user interface display screen and the second user interface display screen are associated with an application, and wherein the second user interface display screen includes one or more additional visual features or functionality relative to the first user interface display screen.
